(19) United States
(12) Patent Application Publication
(10) Pub. No.: US 2025/0044152 A1
(43) Pub. Date: Feb. 6, 2025

(54) MULTIPLEXED BRILLOUIN MICROSCOPY SYSTEMS AND METHODS

(71) Applicant: UNIVERSITY OF MARYLAND, COLLEGE PARK, College Park, MD (US)

(72) Inventor: Giuliano SCARCELLI, Washington, DC (US)

(21) Appl. No.: 18/788,105

(22) Filed: Jul. 29, 2024

Related U.S. Application Data
(60) Provisional application No. 63/516,854, filed on Jul. 31, 2023.

(51) Int. Cl. G01J 3/44; G01J 3/02

(52) U.S. Cl. CPC G01J 3/4412; G01J 3/021; G01J 3/0218

(57) ABSTRACT

A multiplexed Brillouin microscopy system can include an optical assembly, a multiplexing module, and a Brillouin spectrometer. The optical assembly can direct interrogating light to a sample along an illumination optical path and can collect Brillouin scattered light from the sample along a detection optical path. The illumination and detection optical paths can be on a same side of the sample. The multiplexing module can receive the collected Brillouin scattered light from the optical assembly and can process the collected Brillouin scattered light into one or more input beams. The Brillouin spectrometer can receive the one or more input beams from the multiplexing module and can simultaneously process the one or more input beams for detection. In some embodiments, the system can be configured for axial multiplexing with parallel processing, mode multiplexing with parallel processing, or mode multiplexing without parallel processing.

### CROSS-REFERENCE TO RELATED APPLICATIONS

The present application claims the benefit of and priority under 35 U.S.C. § 119 (c) to and is a non-provisional of U.S. Provisional Application No. 63/516,854, filed Jul. 31, 2023, entitled “Systems and Methods for Multiplexed Brillouin Microscopy,” which is hereby incorporated by reference herein in its entirety.

### FIELD

The present disclosure relates generally to microscopy, and more particularly, to microscopy systems that perform Brillouin spectrometry with axial or mode-based multiplexing, as well as Brillouin spectrometers capable of simultaneous processing of multiple input beams (e.g., parallelized Brillouin spectrometers).

### BACKGROUND

Brillouin microscopy, which is based on light scattering and has the capability of probing mechanical properties of materials in a non-contact manner, has emerged as a promising modality for mechanical characterization of materials with no perturbation and at high spatial resolution. Modern Brillouin instruments typically employ an optical microscope, a high-resolution spectrometer, and an optical assembly to connect microscopy and spectroscopy portions of the instrument. The microscopy portion of the instrument selects the spatial voxel of the sample to be analyzed, while the spectroscopy portion provides spectral analysis. For example, the spectroscopy portion can assign a color-code with desired spectral signature to each pixel to form an image indicative of the mechanical characterization of the sample.

Historically, Brillouin spectroscopy was performed with Fabry-Perot tandem interferometers. However, such devices have generally been too slow for imaging applications and/or for life science applications, where limited optical power and short measurement times are required. In 2008, a novel spectrometer using Virtually Imaged Phased Array (VIPA) etalons was developed. The VIPA-based spectrometers were capable of acquiring spectra in 1-10 seconds by measuring the whole spectrum simultaneously at high throughput, which enabled applications in biological research as well as in vivo measurement in the clinics. VIPA-based spectrometers have continued to evolve, with current technologies offering spectrum acquisition time under 50 ms. While such reduced spectrum acquisition times are approaching the fundamental limit imposed by the number of photons generated in the spontaneous Brillouin scattering interaction given the optical power bounds for safe operation in biological samples, this measurement speed is still limiting, especially when large areas need to be mapped at high resolution or when phenomena that vary rapidly in time need to be characterized.

To address these acquisition speed limitations in Brillouin microscopy, multiplexing has been explored as a solution. However, prior arrangements for multiplexing employ non-epi-detection geometries (e.g., different directions for input (illumination) and output (detection)). As a result, the sample needs to be accessible from two sides, thereby complicating sample preparation. While some prior Brillouin microscopy systems are configured to operate in epi-detection geometry, such microscopy systems require a non-multiplexed approach (e.g., single point-by-point scanning). Prior Brillouin multiplexing configurations also combined the microscopy and spectroscopy parts in free-space. In such configurations, the microscopy portion acts as an extended source within the spectrometer, which can limit the practical deployment and the alignment/adjustment of the overall instrument since the spectrometer needs to simultaneously perform spectral decomposition and imaging of the extended source.

Embodiments of the disclosed subject matter may address one or more of the above-noted problems and disadvantages, among other things.

### SUMMARY

Embodiments of the disclosed subject matter provide multiplexed Brillouin microscopy systems and methods, including Brillouin spectrometers capable of simultaneously processing multiple input beams or multiple input modes, as well as kits for modification of existing microscopy systems to include multiplexed Brillouin spectroscopy modalities. For example, the disclosed systems and methods can allow for simultaneous Brillouin analysis of multiple points, multiple modes, and/or multiple probes/sources in sample or within a voxel of sample. In contrast to current Brillouin technologies that rely on analysis of a single source from the sample due to the combined requirements of spatial selection and spectral analysis, aspects of the disclosed subject matter can enable the simultaneous acquisition of different sources of Brillouin scattered light from a sample and the corresponding discrimination, parallelization, and/or integration of their Brillouin spectral analysis.

In some embodiments, the Brillouin spectroscopy aspects can be integrated in an cpi-detection (or similar) configuration with the microscopy aspects, which configuration may be useful for settings where only a single side of the sample is available for input/output light access. In some embodiments, one or more optical fibers can be employed to facilitate operation, alignment, and/or adoption within existing microscopy architectures. In some embodiments, the Brillouin spectroscopy aspects can also be combined with other contrast mechanisms (e.g., fluorescence based) and/or imaging modalities, for example, to allow the co-localization of structural, functional, and/or mechanical mapping of materials, such as but not limited to cells, tissues, and biomaterials.

In one or more embodiments, a multiplexed Brillouin microscopy system can comprise an optical assembly, a multiplexing module, and a Brillouin spectrometer. The optical assembly can direct interrogating light to a sample along an illumination optical path. The optical assembly can also collect Brillouin scattered light from the sample along a detection optical path. The illumination and detection optical paths can be on a same side of the sample. The multiplexing module can receive the collected Brillouin scattered light from the optical assembly. The multiplexing module can also process the collected Brillouin scattered light into one or more input beams. The Brillouin spectrometer can receive the one or more input beams from the multiplexing module and can simultaneously process the one or more input beams for detection.

In some embodiments, the multiplexed Brillouin microscopy system can be configured for axial multiplexing with parallel processing, for example, of a lateral series of input beams. Alternatively, in some embodiments, the multiplexed Brillouin microscopy system can be configured for mode multiplexing with parallel processing, for example, of a lateral series of input beams. Alternatively, in some embodiments, the multiplexed Brillouin microscopy system can be configured for mode multiplexing without parallel processing, for example, of a single input beam from a multiple mode fiber.

In one or more embodiments, a parallelized Brillouin spectrometer can comprise one or more first optical elements, a VIPA etalon, one or more second optical elements, and a two-dimensional detector. The one or more first optical elements can be disposed along an optical path between the input beams and the VIPA etalon. The one or more first optical elements can be constructed to modify each of a plurality of input beams. The one or more second optical elements can be constructed to focus an output of the VIPA etalon for each of the modified input beams. The VIPA etalon can be disposed along the optical path between the one or more first optical elements and the one or more second optical elements. The two-dimensional detector can be configured to detect the focused beams from the one or more second optical elements. The one or more second optical elements can be disposed along the optical path between the VIPA etalon and the two-dimensional detector. The one or more first optical elements can be further constructed such that the modified input beams from the one or more first optical elements have a predetermined beam shape and entrance numerical aperture into the VIPA etalon.

Any of the various innovations of this disclosure can be used in combination or separately. This summary is provided to introduce a selection of concepts in a simplified form that are further described below in the detailed description. This summary is not intended to identify key features or essential features of the claimed subject matter, nor is it intended to be used to limit the scope of the claimed subject matter. The foregoing and other objects, features, and advantages of the disclosed technology will become more apparent from the following detailed description, which proceeds with reference to the accompanying figures.

### BRIEF DESCRIPTION OF THE DRAWINGS

Embodiments will hereinafter be described with reference to the accompanying drawings, which have not necessarily been drawn to scale. Where applicable, some elements may be simplified or otherwise not illustrated in order to assist in the illustration and description of underlying features. For example, in some figures, the propagation of light has not been shown or has been illustrated using block arrows or solid/dashed lines rather than employing ray diagrams. Throughout the figures, like reference numerals denote like elements.

FIG. 1 is a simplified schematic diagram of a generalized system for multiplexed Brillouin microscopy, according to one or more embodiments of the disclosed subject matter.

FIG. 2A is a simplified process flow diagram of a multiplexed Brillouin microscopy method, according to one or more embodiments of the disclosed subject matter.

FIG. 2B is a simplified schematic diagram of a Brillouin microscopy system employing axial multiplexing, according to one or more embodiments of the disclosed subject matter.

FIG. 2C is a simplified schematic diagram of a parallelized Brillouin spectrometer for use in a multiplexed system, according to one or more embodiments of the disclosed subject matter.

FIG. 3A is a simplified process flow diagram of another multiplexed Brillouin microscopy method, according to one or more embodiments of the disclosed subject matter.

FIG. 3B is a simplified schematic diagram of a Brillouin microscopy system employing multiplexing with parallel processing, according to one or more embodiments of the disclosed subject matter.

FIG. 4A is a simplified process flow diagram of another multiplexed Brillouin microscopy method, according to one or more embodiments of the disclosed subject matter.

FIG. 4B is a simplified schematic diagram of another Brillouin microscopy system employing mode multiplexing, according to one or more embodiments of the disclosed subject matter.

FIG. 5A is a simplified schematic diagram of a microscope modified by a kit for multiplexed Brillouin microscopy, according to one or more embodiments of the disclosed subject matter.

FIG. 5B is a simplified schematic diagram illustrating an exemplary configuration for a Brillouin spectrometer for use in an add-on module, according to one or more embodiments of the disclosed subject matter.

FIG. 5C is a simplified schematic diagram illustrating an exemplary implementation of a microscope with a Brillouin add-on module, according to one or more embodiments of the disclosed subject matter.

FIG. 6 depicts a generalized example of a computing environment in which the disclosed technologies may be implemented.

### DETAILED DESCRIPTION

### General Considerations

For purposes of this description, certain aspects, advantages, and novel features of the disclosed subject matter are described herein. The disclosed methods and systems should not be construed as being limiting in any way. Instead, the present disclosure is directed toward all novel and nonobvious features and aspects disclosed herein, alone and in various combinations and sub-combinations with one another. The methods and systems are not limited to any specific aspect or feature or combination thereof, nor do the disclosed aspects require that any one or more specific advantages be present, or problems be solved. The technologies from any aspect or example can be combined with the technologies described in any one or more of the other aspects or examples. In view of the many possible aspects to which the principles of the disclosed technology may be applied, it should be recognized that the illustrated aspects of the disclosure are exemplary only and should not be taken as limiting the scope of the disclosed technology.

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed methods can be used in conjunction with other methods. Additionally, the description sometimes uses terms like “provide” or “achieve” to describe the disclosed methods. These terms are high-level abstractions of the actual operations that are performed. The actual operations that correspond to these terms may vary depending on the particular implementation and are readily discernible by one skilled in the art.

The disclosure of numerical ranges should be understood as referring to each discrete point within the range, inclusive of endpoints, unless otherwise noted. Unless otherwise indicated, all numbers expressing quantities of components, molecular weights, percentages, temperatures, times, and so forth, as used in the specification or claims are to be understood as being modified by the term “about.” Accordingly, unless otherwise implicitly or explicitly indicated, or unless the context is properly understood by a person skilled in the art to have a more definitive construction, the numerical parameters set forth are approximations that may depend on the desired properties sought and/or limits of detection under standard test conditions/methods, as known to those skilled in the art. When directly and explicitly distinguishing aspects from discussed prior art, the numbers are not approximates unless the word “about,” “substantially,” or “approximately” is recited. Whenever “substantially,” “approximately,” “about,” or similar language is explicitly used in combination with a specific value, variations up to and including 10% of that value are intended, unless explicitly stated otherwise.

Directions and other relative references may be used to facilitate discussion of the drawings and principles herein but are not intended to be limiting. For example, certain terms may be used such as “inner,” “outer,” “upper,” “lower,” “top,” “bottom,” “interior,” “exterior,” “left,” “right,” “front,” “back,” “rear,” and the like. Such terms are used, where applicable, to provide some clarity of description when dealing with relative relationships, particularly with respect to the illustrated aspects. Such terms are not, however, intended to imply absolute relationships, positions, and/or orientations. For example, with respect to an object, an “upper” part can become a “lower” part simply by turning the object over. Nevertheless, it is still the same part, and the object remains the same.

As used herein, “comprising” means “including,” and the singular forms “a” or “an” or “the” include plural references unless the context clearly dictates otherwise. The term “or” refers to a single element of stated alternative elements or a combination of two or more elements unless the context clearly indicates otherwise.

Although there are alternatives for various components, parameters, operating conditions, etc. set forth herein, that does not mean that those alternatives are necessarily equivalent and/or perform equally well. Nor does it mean that the alternatives are listed in a preferred order, unless stated otherwise. Unless stated otherwise, any of the groups defined below can be substituted or unsubstituted.

Unless explained otherwise, all technical and scientific terms used herein have the same meaning as commonly understood to one skilled in the art to which this disclosure belongs. Although methods and materials similar or equivalent to those described herein can be used in the practice or testing of the present disclosure, suitable methods and materials are described below. The materials, methods, and examples are illustrative only and not intended to be limiting. Features of the presently disclosed subject matter will be apparent from the following detailed description and the appended claims.

### INTRODUCTION

Disclosed herein are systems and methods for multiplexed Brillouin microscopy. In some embodiments, the shortcomings of conventional Brillouin microscopy systems can be addressed by employing multiplexed configurations that are compatible with existing microscopy platforms (e.g., confocal), as well as collimated or fiber-coupled connections between microscopy and spectrometry portions of the instrument, for example, to enhance design robustness, flexibility, and deployment readiness. In some embodiments, the Brillouin microscopy system has an epi-detection configuration (e.g., where an illumination optical path for interrogating light and a detection optical path for collected Brillouin scattered light are on a same side of the sample being imaged).

In some embodiments, the Brillouin microscopy system can employ axial multiplexing with parallel processing. In such embodiments, the illumination of the sample with interrogating light can define axially-stacked Brillouin sources along the coaxially aligned illumination-detection optical paths, and means for multiplexing of axially-illuminated beams can be used to multiplex detection of the axially-stacked Brillouin sources. For example, the means for multiplexing can include a confocal array.

Alternatively, in some embodiments, the Brillouin microscopy system can focus illumination on a single voxel in the sample at a time. In such embodiments, the multiplexing (and associated improvement in measurement speed) can be provided by simultaneously collecting and analyzing all scattered light generated in the voxel via a multimode optical fiber or equivalent optical assembly (fiber or free space). For example, the spectral analysis can be performed by discriminating the different components coming from the single voxel and analyzing them in parallel, or by integrating their output into a single spot at much higher intensity.

In some embodiments, the simultaneous spectral analysis of several points (e.g., multiple input beams) can be performed by a parallelized VIPA-based spectrometer, or by using modified two-dimensional multiplexed spectrometry configurations based on atomic vapors, for example, as disclosed in U.S. Pat. No. 12,019,018, issued Jun. 25, 2024 and entitled “Full-Field Brillouin Microscopy Systems and Methods,” which atomic-vapor-based spectrometry configurations are incorporated by reference herein.

Embodiments of the disclosed subject matter can address difficulties experienced in existing Brillouin microscopy systems and/or provide functionality not previously found in existing Brillouin microscopy systems. Embodiments of the disclosed subject matter may thus offer one or more of the following features:
Epi-detection: Some embodiments can provide for Brillouin spectroscopy using epi-detection (or similar) in a multiplexed space, for example, where input and output directions can be on the same side of the sample (e.g., on the same axis). In some embodiments, the multiplexing detection direction is along the illumination direction, such that only one point of access in the sample is needed, thereby minimizing, or at least reducing, the amount of sample preparation.
Coupling: Some embodiments can provide optical connection or coupling of microscopy and spectroscopy parts of the instrument via optical fiber, or pinhole/spatial filtering, in a multiplexed configuration. In some embodiments, the coupling can allow the microscopy and spectroscopy parts of the instrument to be substantially independent, such that they can be separately optimized for improved efficiency and/or stability. Although optical fiber coupling may be preferred for some applications, the use of free-space optics for coupling is also possible according to one or more contemplated embodiments. For example, in some embodiments, multiple pinholes or spatial filters can be used to provide collimated beams as an input into a parallelized Brillouin spectrometer.
Compatibility: Some embodiments can offer compatibility with existing microscopy architecture, for example, confocal microscopes. Some embodiments can provide a kit to add a Brillouin multiplexed modality to an existing microscope.

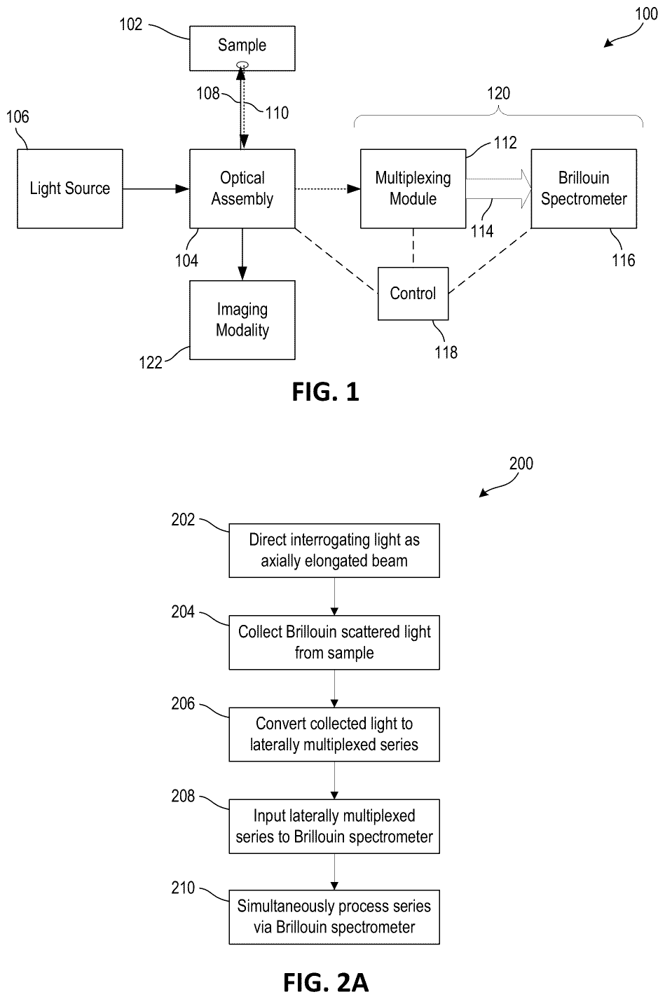

FIG. 1 shows aspects of a multiplexed Brillouin microscopy system 100 for analyzing a sample 102, according to one or more embodiments of the disclosed subject matter. In the illustrated example, the system 100 includes an optical assembly 104, a light source 106 (e.g., laser), a multiplexing module 112, a Brillouin spectrometer 116, and a control system 118. In some embodiments, the multiplexing module 112, the Brillouin spectrometer 116, and/or the control system 118 can be configured as a kit or add-on module 120, for example, for modifying an existing microscope (e.g., epi-detection microscope) to include a multiplexed Brillouin spectroscopy modality. Alternatively, in some embodiments, the add-on module 120 may include only the multiplexing module 112 (with or without control system 118), for example, for use with an existing Brillouin spectrometer and microscope. In some embodiments, the add-on module 120 may also include one or more additional optical components for modifying the optical assembly 104, for example, interrogating light beam shaping elements and/or collected light directing elements (e.g., flip mirror, dichroic, etc.).

The optical assembly 104 can include an objective lens and can be configured to operate in an epi-detection configuration with respect to sample 102. The optical assembly 104 can direct (e.g., via the objective lens) interrogating light from light source 106 along an illumination optical path 108 to the sample 102. The optical assembly 104 can also collect (e.g., via the same objective lens as the interrogating light or a different objective lens) Brillouin scattered light from the sample along a detection optical path 110. In the illustrated example of an epi-detection configuration, the illumination optical path 108 and the detection optical path 110 are substantially coincident (e.g., along an axial direction extending from the objective lens to/into the sample 102). Alternatively, in some embodiments, the illumination and detection optical paths are not coincident (e.g., due to use of different objective lens for interrogating and Brillouin scattered light, and/or differences in depths of focus for the interrogating and collected Brillouin scattered light) but are on a same side of the sample 102.

In some embodiments, the optical assembly 104 can employ a beam splitter, for example, to direct interrogating light from the light source to the sample and direct collected Brillouin scattered light from the sample to the multiplexing module. Alternatively, in some embodiments, operation of the microscopy portion of the system (e.g., optical assembly 104) can employ optical fibers (e.g. dual-clad or few-modes or multi-modes), for example, with a circulator (e.g., instead of a beam splitter), gradient refractive index (GRIN) lenses, and/or other optical elements to enable Brillouin endoscopy.

In some embodiments, the light source 106 and/or the optical assembly 104 can be configured to direct the interrogating light at and/or within the sample 102 as an elongated beam (e.g., elongated with respect to the axial direction) so as to illuminate multiple points in the sample simultaneously. In some embodiments, the elongated interrogating light beam can be used to provide axial multiplexing, for example, where Brillouin scattered light from multiple points illuminated by the elongated beam is simultaneously processed by the Brillouin spectrometer 116 (e.g., a parallelized Brillouin spectrometer). For example, the interrogating light can be in the form of a pencil beam or a Bessel beam (e.g., a needle beam).

Alternatively, in some embodiments, the light source 106 and/or the optical assembly 104 can be configured to focus the interrogating light at a single spot (e.g., voxel) on or within the sample 102. In some embodiments, the focused spot can be used to provide to provide mode multiplexing, for example, where Brillouin scattered light from the single spot that would normally be lost or rejected in conventional setups (e.g., featuring strict confocality via a pinhole or a single mode optical fiber) is instead captured for input to the Brillouin spectrometer 116. In some embodiments, the captured Brillouin scattered light can be simultaneously processed by the Brillouin spectrometer 116 (e.g., a parallelized Brillouin spectrometer), for example, as separate input beams. Alternatively, in some embodiments, the captured Brillouin scattered light can be processed together by the Brillouin spectrometer 116 (e.g., a non-parallelized Brillouin spectrometer), for example, as a single input beam.

In the illustrated example, the optical assembly 104 can direct the collected Brillouin scattered light from the sample 102 to a multiplexing module 112, which processes the collected light into input 114 to the Brillouin spectrometer 116. In some embodiments, such as when the Brillouin spectrometer 116 has a parallelized configuration, the input 114 provided by the multiplexing module 112 can be a plurality of input beams, for example, a laterally multiplexed series of input beams. In some embodiments, such as when the Brillouin spectrometer 116 has a non-parallelized configuration, the input 114 provided by the multiplexing module 112 can be a single input beam. In some embodiments, the multiplexing module 112 can include one or more optical fibers, or optical-fiber-based device, for generating and/or providing the input 114 to the Brillouin spectrometer 116. For example, the multiplexing module 112 can employ a lateral array of single mode fibers, a photonic lantern, and/or a multi-mode fiber.

In some embodiments, the system 100 can optionally include one or more other imaging modalities 122. Although only a single imaging modality 122 is shown in FIG. 1, multiple additional imaging modalities are also possible according to one or more contemplated embodiments. The imaging modality 122 can be configured to operate simultaneously with the Brillouin spectroscopy modality or alternating with the Brillouin spectroscopy modality (e.g., with a flip mirror used to switch between the different modalities). In some embodiments, the other imaging modality 122 can employ the same epi-detection configuration as the Brillouin spectroscopy modality. Alternatively or additionally, in some embodiments, the other imaging modality 122 can employ a different detection configuration (e.g., trans-illumination). Such other imaging modalities can include but are not limited to bright-field microscopy, fluorescence microscopy, confocal microscopy, optical coherence tomography, and Raman spectroscopy.

In some embodiments, control system 118 can be operatively connected to the Brillouin spectrometer 116 to receive and/or process data therefrom. For example, the control system 118 can form an image of and/or assign a Brillouin metric to one or more points (e.g., pixels) based on the Brillouin scattered light from the sample 102 detected by a detector of the Brillouin spectrometer 116. In some embodiments, the control system 118 can optionally be operatively connected to and configured to control aspects of the optical assembly 104 (e.g., to control or calibrate a beam shaping element for the interrogating light), the multiplexing module 112 (e.g., to control or calibrate a potential defining diaphragm therein), and/or the Brillouin spectrometer 116 (e.g., to control or calibrate a beam shaping element for the input beams, to switch between detection and calibration modes of the spectrometer, etc.). In some embodiments, the control system 118 can optionally be operatively connected to and configured to control aspects of the other imaging modality 122, to receive and/or process data from the other imaging modality 122, and/or to coordinate operation of the other imaging modality 122 and the Brillouin spectroscopy modality.

### Axial Multiplexing

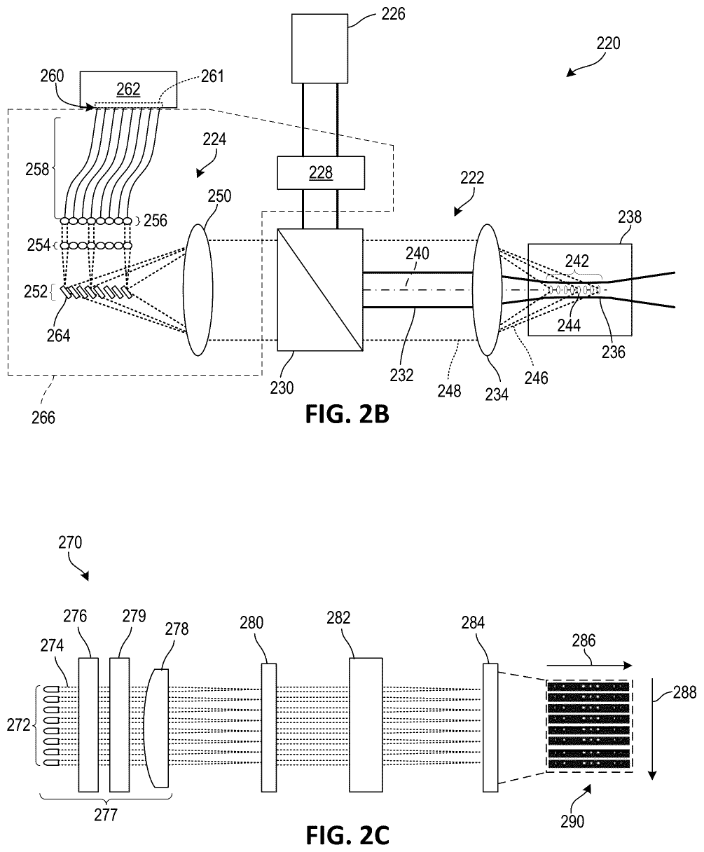

FIG. 2A illustrates aspects of a method 200 for multiplexed Brillouin microscopy, for example, axial multiplexing with parallel processing. The method 200 can initiate at process block 202, where interrogating light is directed as an axially-elongated beam on and/or within a sample. The axially-elongated beam can induce Brillouin scattering at multiple points along the illuminated optical path within the sample. In some embodiments, the axially-elongated beam can be a Gaussian beam. Alternatively, in some embodiments, the axially-elongated beam can be a pencil beam, a Bessel beam (e.g., needle beam), or a multifocal array beam. In some embodiments, any sidelobes present in the axially-elongated beam can be eliminated, or at least reduced, via known techniques in order to minimize, or at least reduce, energy loss. In some embodiments, such as when probing turbid materials, the axially-elongated beam can be further modified via adaptive optics (e.g., beam shaping elements, such as a deformable mirror) to enhance penetration into the sample. For example, such adaptive optics modifications can include, but are not limited to, those disclosed in Edrei et al., “Adaptive optics in spectroscopy and densely labeled fluorescence applications,” Optica, December 2018, 26(26): pp. 33865-77, which adaptive optics modifications are incorporated by reference herein.

The method 200 can proceed to process block 204, where the Brillouin scattered light from the sample can be collected. In some embodiments, the Brillouin scattered light can be collected via a detection optical path (e.g., from the sample to an optical assembly of the microscope) that is on a same side of the sample as an illumination optical path for the interrogating light (e.g., from the optical assembly of the microscope to the sample). In some embodiments, the Brillouin scattered light can be collected from the detection optical path using the same objective lens in the optical assembly of the microscope as used to direct the interrogating light along the illumination optical path. In such embodiments, the objective lens can have different numerical apertures with respect to the interrogating and collected Brillouin scattered light to yield different depths of focus for each, for example, a relatively lower numerical aperture for the illumination optical path to provide a relatively longer depth of focus, and a relatively higher numerical aperture for the detection optical path to provide a relatively shorter depth of focus.

The method 200 can proceed to process block 206, where the collected Brillouin scattered light can be converted to multiple beams for input into a Brillouin spectrometer, for example, by a multiplexing module. In some embodiments, the collected Brillouin scattered light can be converted into a laterally multiplexed series of input beams, for example, where each input beam corresponding to a different one of the illuminated points in the sample. In some embodiments, the conversion to multiple beams by the multiplexing module can include means for multiplexing of axially-illuminated beams. For example, the means for multiplexing can include a series of pinholes and one or more optical elements for re-collimating the beam output from each pinhole for input to the spectrometer. Alternatively or additionally, the means for multiplexing can include a series (e.g., a lateral array) of single mode fibers. Alternatively or additionally, the means for multiplexing can include a series (e.g., lateral array) of non-occluding mirrors (e.g., micromirrors). Other options for the means for multiplexing are also possible according to one or more contemplated embodiments, such as but not limited to adaptations of (1) the multi-plane prism approach disclosed in Xiao et al., “High-contrast multi-focus microscopy with a single camera and z-splitter prism,” Optica, November 2020, 7(11): pp. 1477-86, (2) the multiple reflecting pinhole approach disclosed in Badon et al., “Video-rate large-scale imaging with multi-Z confocal microscopy,” Optica, April 2019, 6(4): pp. 389-95, and (3) the micromirror array approach disclosed in Yang et al., “Z-microscopy for parallel axial imaging with micro mirror array,” Applied Physics Letters, December 2012, 101:231111, which approaches are hereby incorporated by reference herein.

The method 200 can proceed to process block 208, where the multiple beams can be input to the Brillouin spectrometer, for example, as a laterally multiplexed series from the multiplexing module. In some embodiments, the input into the Brillouin spectrometer can be via a linear array of single mode fibers, for example, attached to respective fiber couplers of the spectrometer. Alternatively, in some embodiments, the input into the Brillouin spectrometer can be via free space optics.

The method 200 can proceed to process block 210, where the multiple beams can be simultaneously processed by the Brillouin spectrometer, for example, such that an optical train of the spectrometer induces spectral dispersion for each input beam (e.g., in a direction perpendicular to the direction of multiplexing of the lateral array of beams) onto a detection plane of a two-dimensional detector (e.g., complementary metal-oxide-semiconductor (CMOS) device, charge-coupled device (CCD), photomultiplier tube (PMT) array, avalanche photodiode (APD) array, etc.) of the spectrometer. In some embodiments, the Brillouin spectrometer can include one or more virtually imaged phased array (VIPA) etalons. For example, the input to the VIPA etalon can be an array of collimated beams, rather than an extended line to be imaged, which are properly focused into the etalon for optimal performance. In some embodiments, the array of collimated beams can be provided as input to the Brillouin spectrometer (e.g., from the multiplexing module). Alternatively, the multiple beams input to the Brillouin spectrometer can be processed by optical element(s) thereof (e.g., one or more first optical elements) into collimated beams properly focused, or a series of beams that are directly modified to the proper focusing numerical aperture, for input to the VIPA etalon. In some embodiments, the Brillouin spectrometer (or a controller thereof) can image multiple points in the sample based at least in part on the detected spectral dispersion of the simultaneously processed multiple input beams. Alternatively or additionally, the Brillouin spectrometer (or a controller thereof) can assign Brillouin metrics (e.g., longitudinal modulus) to the multiple points in the sample based at least in part on the detected spectral dispersion of the simultaneously processed multiple input beams.

Although some of blocks 202-210 of method 200 have been described as being performed once, in some embodiments, multiple repetitions of a particular process block may be employed before proceeding to the next decision block or process block. In addition, although blocks 202-210 of method 200 have been separately illustrated and described, in some embodiments, process blocks may be combined and performed together (simultaneously or sequentially). Moreover, although FIG. 2A illustrates a particular order for blocks 202-210, embodiments of the disclosed subject matter are not limited thereto. Indeed, in certain embodiments, the blocks may occur in a different order than illustrated or simultaneously with other blocks. In some embodiments, method 200 may comprise only some of blocks 202-210 of FIG. 2A.

FIG. 2B shows an exemplary Brillouin microscopy system 220 that employs axial multiplexing, for example, for use in performing the method 200 of FIG. 2A. In the illustrated example of FIG. 2B, the system 220 includes an optical assembly 222, a multiplexing module 224, a light source 226 (e.g., laser), a beam shaping optical element 228, and a Brillouin spectrometer 262 (e.g., a parallelized Brillouin spectrometer). The multiplexing module 224 may be configured as a kit 266 for modification of an existing microscope. In some embodiments, the beam shaping optical element 228 and/or the Brillouin spectrometer 262 may also be considered part of kit 266.

The optical assembly 222 includes a beam splitter 230 and an objective lens 234. An interrogating light beam 232 from the light source 226 is directed by beam splitter 230 along an illumination optical path (e.g., parallel to axial direction 240 in the illustrated example) and focused by objective lens 234 to form an axially-elongated beam 236 within sample 238. Brillouin scattered light 246 from multiple axially-stacked sources 244 within an elongated excited region 242 in the sample 238 is collected by objective lens 234 as collected beam 248 along a detection optical path (e.g., parallel to axial direction 240 in the illustrated example).

The collected beam 248 is then directed by beam splitter 230 to the multiplexing module 224 for further processing prior to input to the Brillouin spectrometer 262. The multiplexing module 224 includes a focusing lens 250 (e.g., tube lens), multiplexing means 252, collimating means 254, coupling means 256, and fiber array 258. Alternatively, in some embodiments, the focusing lens 250 can be part of an existing microscope rather than part of the multiplexing module 224. In the illustrated example, the multiplexing means 252 is a lateral array of non-occluding micromirrors 264, with each micromirror 264 acting as a different confocal pinhole. In the illustrated example, the collimating means 254 is an array of lenses, the coupling means 256 is another array of lenses (e.g., fiber couplers), and the fiber array 258 is an array of single mode fibers. However, other means and/or configurations for the multiplexing module 224 are also possible according to one or more contemplated embodiments, for example, as described elsewhere herein.

In operation, the light beam from the light source 226 can be shaped by beam shaping optical element 228 prior to objective lens 234 such that the interrogating light beam 232 forms the axially-elongated beam 236 within the sample. For example, the beam shaping optical element 228 can include, but is not limited to, a spatial light modulator (SLM), a digital micromirror device (DMD), a diffractive optical element, or a metalens. The axially-elongated beam 236 induces Brillouin scattering along its path, in essence, providing a series of axially-stacked sources 244 of Brillouin photons 246 that are collected by the same objective lens 234 along the detection path. Since the spontaneous scattering process is extremely weak, the system can operate in the non-depleted pump regime, for example, with each of the axially-stacked sources 244 being excited by the same optical power from objective lens 234. Unlike previous multiplexed configurations, the detection path is on the same side of the sample 238 as the illumination path, thus allowing the traditional architecture of an epi-detection confocal microscope to be used.

In order to efficiently take advantage of the multiplex gains, the optical arrangement of the confocal pinhole of typical microscopes can be modified, for example, to convert the collected Brillouin scattered light 246 from the axially-stacked sources 244 to a series of laterally-multiplexed input beams 260 (e.g., microbeams) that can enter (e.g., via an array 261 of fiber couplers) Brillouin spectrometer 262 (e.g., a parallelized VIPA spectrometer, such as that shown in FIG. 2C). In the illustrated example of FIG. 2B, the array of non-occluding micromirrors 264 can function as an array of confocal pinholes, with light from each micromirror 264 being collimated by a respective lens of collimating means 254 and then coupled by a respective lens of coupling means 256 into a respective single mode fiber of the fiber array 258. Alternatively, in some embodiments, the fiber array 258 itself could function as confocal pinholes (e.g., with or without use of mirrors 264 and/or collimating means 254 for redirecting light to the fiber array). Alternatively, in some embodiments, the processing of light into a lateral array of beams for input into the spectrometer 262 can be done in free-space, for example, by re-collimating beam outputs from each pinhole of a linear array of confocal pinholes.

The multiplexing advantage offered by the system of FIG. 2B can be quantified by evaluating the difference between illumination and detection beam paths. Although illumination and detection are nearly along the same axis 240, they have different focusing properties. In particular, the interrogating light beam 236 is elongated (e.g., depth of focus is long), and the beam path for the collected Brillouin scattered light is highly focused (e.g., depth of focus is short) that defines the size of the Brillouin sources 244. The depth of focus of a beam is generally dependent on numerical aperture (NA) of the corresponding lens or focusing system, with high NA leading to short depth of focus, low NA leading to high depth of focus. The ratio of depth of focus between illumination and detection quantifies the multiplexing advantage. In some embodiments, the ratio of depth of focus for illumination (e.g., for interrogating beam 232) to depth of focus for detection (e.g., for collected beam 248) is at least 2.

Several techniques are available for generating the axial multiplexing illustrated in FIG. 2A. For example, the axial multiplexing can employ the technique described in Cao et al., “Optical-resolution photoacoustic microscopy with a needle-shaped beam,” Nature Photonics, January 2023, 17: pp. 89-95, which technique is incorporated herein by reference. In some embodiments, the axial multiplexing can be achieved by the combination of a Gaussian beam elongated due to low illumination NA together with the collection via a high NA lens. In this case, the depth of focus is based on the square of numerical aperture (NA²), so the multiplexing advantage can be quantified as the ratio of square of the illumination/detection NAs. However, such a configuration may be suboptimal, since the lateral extent of illumination and detection beam paths is not the same, which can lead to reduced overlap of illumination and detection beam paths and thus lower Brillouin efficiency.

Alternatively, in some embodiments, the axial multiplexing is achieved using a pencil beam, a Bessel beam (e.g., needle beam), or a multifocal array beam as the axially-elongated beam. Such beams can offer an improved ratio between lateral extent and depth of focus as compared to Gaussian beams. However, such beams may also lose energy to their sidelobes. In some embodiments, techniques known in the art for reducing and/or eliminating these sidelobes can be employed to reduce such energy loss. Alternatively or additionally, in some embodiments, the axially-elongated beam can be optimized via adaptive optics methods, for example, to better penetrate and/or probe turbid materials. Such adaptive optics methods can include, but are not limited to, that described in Edrei et al., “Adaptive optics in spectroscopy and densely labeled-fluorescence applications,” Optics Express, 2018, 26:33865, which methods are incorporated herein by reference.

As noted above, in some embodiments, the multiplexing module 224 and the beam shaping optical element 228 may be considered part of a kit 266, for modifying an existing microscope (e.g., confocal) to offer multiplexed Brillouin spectroscopy. The beam shaping optical element 228 modifies the characteristics of the interrogating light, e.g., to form an axially-elongated beam within the sample 238. In some embodiments, the collection train of the existing confocal microscope need not be modified, at least from objective lens 234 to lens 250. Rather, the arrangement of the confocal pinhole of the existing microscope can be modified, for example, to direct light to multiplexing means 252. In some embodiments, the provision of the beam shaping optical element 228 and/or the multiplexing means 252 may not disturb the path of the confocal modality, for example, by inserting or engaging these elements using flip mirrors along the optical train.

### Parallelized Brillouin Spectrometer

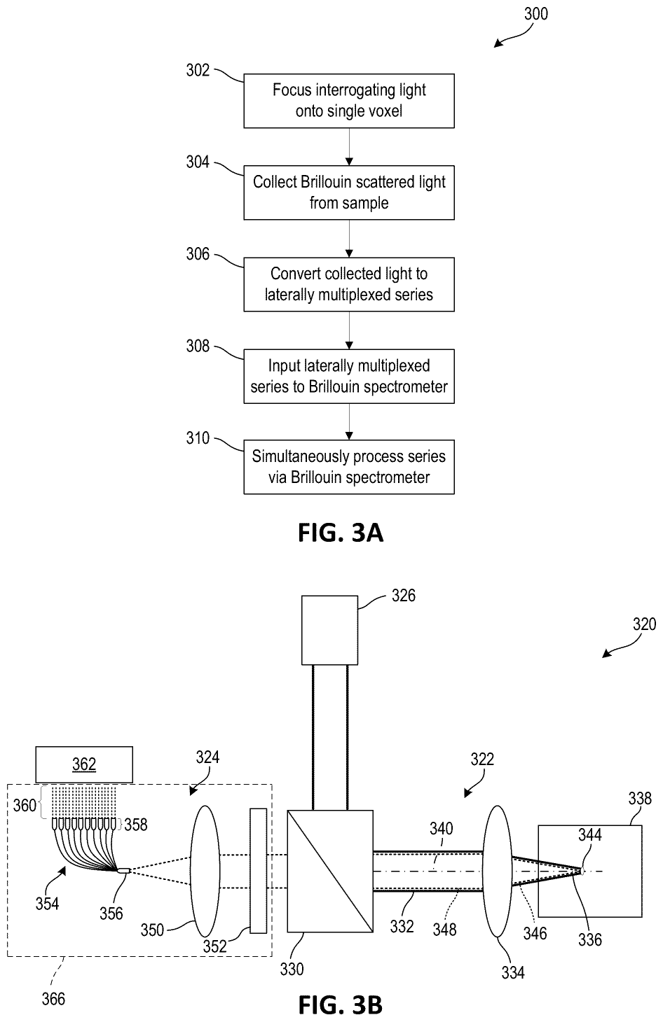

FIG. 2C shows an exemplary parallelized Brillouin spectrometer 270 that may be used to simultaneously process multiple input beams from a multiplexing module (e.g., for use as spectrometer 262 in FIG. 2B and/or spectrometer 362 in FIG. 3B). In the illustrated example of FIG. 2C, the spectrometer 270 includes one or more first optical elements 277, a VIPA etalon 280, one or more second optical elements 282, and a two-dimensional detector 284. The one or more first optical elements 277 can include an array 272 of coupling elements (e.g., fiber couplers), for example, each coupling element connecting to an output end of a respective optical fiber of the multiplexing module and receiving an input beam of collected Brillouin scattered light therefrom. Generally, these types of optical elements serve the purpose of creating collimated beams of Gaussian-like transverse profile. In some embodiments, the one or more first optical elements 277 can optionally include an optical element 276 for beam expansion or reduction, a lens 278 (e.g., cylindrical lens), and/or a beam shaping optical element 279 (e.g., SLM, DMD, deformable mirror, metalens). In some embodiments, the one or more first optical elements 277 (with or without optional elements 276, 278, and 279) can modify and/or provide the input beams from the multiplexing module as respective beams 274 with a desired beam shape and entrance NA into the VIPA etalon 280. In some embodiments, beam shaping elements 279 may be needed in case the transverse profile (shape) of the received input beams from the multiplexing module is far from a Gaussian-like profile. In some embodiments, the optical element 276 for expansion/reduction of the beam size and/or cylindrical lens 278 are configured so that each of the multiplexed input beam has an optimal entrance NA into the etalon. The entrance NA of a beam into the VIPA etalon can determine the extent of an envelope function that is superimposed to the spectral dispersion of the signal. As used herein, “optimal” NA is defined so that the extent of the envelope only covers one, two, or at most three diffraction orders from the VIPA dispersion, for example, such that the full width half maximum of the envelope is on the order of one free spectral range of the VIPA etalon.

The one or more second optical elements 282 can focus the output from the VIPA etalon 280 onto a detection plane of two-dimensional detector 284. In some embodiments, the one or more second optical elements 282 can include a focusing or Fourier-transforming lens assembly (e.g., combinations of spherical lenses, double-cylindrical lenses, or arrays of lenses, such as those lens arrangements disclosed in U.S. Pat. No. 11,143,555, issued Oct. 12, 2021 and entitled “Methods and Devices for Reducing Spectral Noise and Spectrometry Systems Employing Such Devices,” which lens arrangements are incorporated herein by reference). The spectrometer 270 can efficiently induce spectral dispersion of each input beam onto the detector 284 in a direction 286 orthogonal to the multiplexed direction 288, as shown in panel 290. Note that panel 290 has been rotated in FIG. 2C solely for purposes of illustration-direction 286 actually extends perpendicular to the page at the detection plane of detector 284.

In the illustrated example of FIG. 2C, the input to the VIPA spectrometer 270 is an array of input beams (e.g., beams 274), rather than an extended line imaged in conventional parallelized spectrometers. The configuration of spectrometer 270 can thus offer an improved optical condition as compared to prior parallelized spectrometers, which had to deal with extended sources due to the free-space orthogonal coupling of the microscopy and spectroscopy parts of the instrument. By employing the VIPA spectrometer 270 of FIG. 2C in the disclosed multiplexed configurations, the optical configuration of the parallelized VIPA spectrometer 270 can be simplified in terms of optical elements, optimized in terms of throughput, and miniaturized in terms of physical dimensions compared to prior parallelized spectrometers. Namely, each separate beam 274 in the array can be treated and optimized like in non-parallelized VIPA spectrometers, in particular, to have optimal shape and entrance NA into the VIPA etalon, for example, via the one or more first optical elements 277 as described above. Moreover, the configuration of VIPA spectrometer 270 is compatible with many existing VIPA spectrometer enhancements (e.g., apodization, coronagraphy, etc.), as well as known methods to increase spectral extinction of the spectrometer and/or rejection of unwanted scattered light, for example, via atomic vapor notch filters such as those filters described in U.S. Pat. No. 12,019,018, issued Jun. 25, 2024 and entitled “Full-field Brillouin Microscopy Systems and Methods,” which filters are incorporated by reference herein.

Mode Multiplexing with Parallel Processing

In some embodiments, instead of increasing the speed of Brillouin spectra acquisition by increasing the number of voxels that can be simultaneously measured, the speed can be instead be improved by increasing the throughput of acquisition from a single voxel, for example, by increasing the amount of Brillouin scattered light that is collected per input illumination (e.g., mode multiplexing). Thus, instead of using a parallelized spectrometer to simultaneously analyze multiple points in the sample, the parallelized spectrometer can be used to discriminate and simultaneously analyze the output of different input beams corresponding to different modes emitted from the same point.

For example, FIG. 3A illustrates aspects of a method 300 for Brillouin microscopy employing mode multiplexing with parallel processing. The method 300 can initiate at process block 302, where interrogating light is focused on a single voxel within the sample. The method 300 can proceed to process block 304, where the Brillouin scattered light from the single voxel can be collected. In some embodiments, the Brillouin scattered light can be collected via a detection optical path (e.g., from the sample to an optical assembly of the microscope) that is on a same side of the sample as an illumination optical path for the interrogating light (e.g., from the optical assembly of the microscope to the sample). In some embodiments, the Brillouin scattered light can be collected from the detection optical path using the same objective lens in the optical assembly of the microscope as used to direct the interrogating light along the illumination optical path. In such embodiments, the objective lens can have a same (or substantially same) NA with respect to the interrogating and collected Brillouin scattered light. In some embodiments, the illumination and detection optical paths (e.g., from the objective lens to the sample) can be substantially coincident.

The method 300 can proceed to process block 306, where the collected Brillouin scattered light can be converted to multiple beams for input into a Brillouin spectrometer, for example, by a multiplexing module. In some embodiments, the collected Brillouin scattered light can be converted into a laterally multiplexed series of input beams, for example, where each input beam corresponding to a different mode emitted from the illuminated voxel in the sample. In some embodiments, the conversion to multiple beams by the multiplexing module can include means for converting a single light beam to a laterally multiplexed series of separate beams. In some embodiments, the means for converting can include a photonic lantern, where a larger aperture input end (e.g., ≥0.3 Airy unit) receives the Brillouin scattered light and splits it into individual single mode fibers at an output end. For example, the photonic lantern can be similar to the photonic lantern described in de Sivry-Houle et al., “All-fiber few-mode optical coherence tomography using a modally-specific photonic lantern,” Biomedical Optics Express, September 2021, 12(9): pp. 5704-19, which photonic lantern is incorporated by reference herein.

Alternatively, in some embodiments, the means for converting can include a bundle of multiple fibers (e.g., single mode fibers). The bundle can be constructed such that an input end thereof has a substantially circular configuration (e.g., with fiber ends arranged in a circular and/or hexagonal array) and an output end thereof has a substantially linear configuration (e.g., with fiber ends arranged along a common line). Alternatively or additionally, free-space optics and/or fiber-coupled optical arrangements can be used to transform the round aperture of the collected Brillouin scattered light into a line beam or linear array of separate beams for input to the Brillouin spectrometer, for example, by using one or more beam shaping optical elements between the optical assembly and the spectrometer (e.g., after the confocal pinhole).

The method 300 can proceed to process block 308, where the multiple beams can be input to the Brillouin spectrometer, for example, as a laterally multiplexed series from the multiplexing module. In some embodiments, the input into the Brillouin spectrometer can be via a plurality of fiber-based outputs (e.g., single mode fiber ends of the photonic lantern), for example, attached to respective fiber couplers of the spectrometer. Alternatively, in some embodiments, the input into the Brillouin spectrometer can be via free space optics.

The method 300 can proceed to process block 310, where the multiple beams can be simultaneously processed by the Brillouin spectrometer, for example, such that an optical train of the spectrometer induces spectral dispersion for each input beam (e.g., in a direction perpendicular to the direction of multiplexing of the lateral array of beams) onto a detection plane of a two-dimensional detector (e.g., CMOS device, CCD, PMT array, APD array, etc.) of the spectrometer. In some embodiments, the Brillouin spectrometer can include one or more VIPA etalons. For example, the input to the VIPA etalon can be an array of collimated beams, rather than an extended line to be imaged. In some embodiments, the array of collimated beams can be provided as input to the Brillouin spectrometer (e.g., from the multiplexing module). Alternatively, the multiple beams input to the Brillouin spectrometer can be processed by optical element(s) thereof (e.g., one or more first optical elements) into collimated beams for input to the VIPA etalon. In some embodiments, the Brillouin spectrometer (or a controller thereof) can image a single point in the sample based at least in part on the detected spectral dispersion of the simultaneously processed multiple input beams. Alternatively or additionally, the Brillouin spectrometer (or a controller thereof) can assign a Brillouin metric (e.g., longitudinal modulus) to the single point in the sample based at least in part on the detected spectral dispersion of the simultaneously processed multiple input beams. In some embodiments, imaging or assigning a metric to other points in the sample can be obtained by repeating method 300 for those other points.

Although some of blocks 302-310 of method 300 have been described as being performed once, in some embodiments, multiple repetitions of a particular process block may be employed before proceeding to the next decision block or process block. In addition, although blocks 302-310 of method 300 have been separately illustrated and described, in some embodiments, process blocks may be combined and performed together (simultaneously or sequentially). Moreover, although FIG. 3A illustrates a particular order for blocks 302-310, embodiments of the disclosed subject matter are not limited thereto. Indeed, in certain embodiments, the blocks may occur in a different order than illustrated or simultaneously with other blocks. In some embodiments, method 300 may comprise only some of blocks 302-310 of FIG. 3A.

FIG. 3B shows an exemplary Brillouin microscopy system 320 that employs mode multiplexing, for example, for use in performing the method 300 of FIG. 3A. In the illustrated example of FIG. 3B, the system 320 includes an optical assembly 322, a multiplexing module 324, a light source 326 (e.g., laser), and a Brillouin spectrometer 362 (e.g., a parallelized Brillouin spectrometer, such as Brillouin spectrometer 270 of FIG. 2C). The multiplexing module 324 may be configured as a kit 366 for modification of an existing microscope. In some embodiments, the Brillouin spectrometer 362 may also be considered part of kit 366.

The optical assembly 322 includes a beam splitter 330 and an objective lens 334. An interrogating light beam 332 from the light source 326 is directed by beam splitter 330 along an illumination optical path (e.g., parallel to axial direction 340 in the illustrated example) and focused by objective lens 334 as a focused beam 336 onto a single voxel 344 within sample 338. Brillouin scattered light 346 from the single voxel 344 in the sample 338 is collected by objective lens 334 as collected beam 348 along a detection optical path (e.g., parallel to axial direction 340 in the illustrated example). In the illustrated example, the illumination optical path and the detection optical path are substantially coincident.

The collected beam 348 is then directed by beam splitter 330 to the multiplexing module 324 for further processing prior to input to the Brillouin spectrometer 362. The multiplexing module 324 includes a focusing lens 350 (e.g., tube lens), a potential defining diaphragm 352, and multiplexing means 354. Alternatively, in some embodiments, the focusing lens 350 and/or diaphragm 352 can be part of an existing microscope rather than part of the multiplexing module 324. In the illustrated example, the multiplexing means 354 is a photonic lantern with an input end 356 receiving the collected Brillouin scattered light and an output end 358 from which a laterally multiplexed series 360 of input beams are provided to the spectrometer 362. The input end 356 can have a larger aperture (e.g., ≥0.3 Airy unit) that collects the multiple modes from the single point but then such light is physically split into several individual single mode fibers at the output end 358. The single mode fibers can be arrayed laterally and their output beams recollimated to take advantage of the parallelization configuration of the spectrometer (e.g., as described with respect to FIG. 2C). Other means and/or configurations for the multiplexing module 324 are also possible according to one or more contemplated embodiments, for example, as described elsewhere herein.

The system 320 of FIG. 3B may resemble a conventional confocal Brillouin microscope, with input beam directed to and output beam collected from the sample through the same objective lens 334 in epi-detection configuration. However, the system 320 is capable of increased measurement throughput by enabling the collection and analysis of all the Brillouin light (or at least more modes thereof) emitted by an illuminated voxel 344 in the sample 338. Conventional single-voxel Brillouin microscopes have been limited in throughput by the requirement for the spectrometer to operate with nearly clean collimated Gaussian beams, which further results a requirement on the microscope side to collect light from ideal point sources (which create perfectly collimated Gaussian beams). In conventional systems, this collection is obtained with either very small confocal pinholes (e.g., much smaller than the size of an Airy unit of the microscope) or a single-mode fiber acting as infinitely small confocal pinhole. An infinitely small confocal pinhole on the detection side only detects light from a small portion of the illuminated voxel, because of suboptimal overlap between illumination/detection paths and rejection of slightly off-axis emitted photons. In conventional confocal microscopes that do not have this detection constraint, the size of the confocal pinhole can be tuned relative to the size of the Airy unit to optimize the tradeoff between sectioning/resolution and collection/throughput. In the system 320 of FIG. 3B, the same optimization can be obtained by using the multiplexing means 354, because it relaxes the constraints on the acceptance angle of the coupled light and presents a larger input aperture. Thus, the configuration of system 320 allows the focusing characteristics of the collection optics of the microscope (e.g. objective lens 334, focusing lens 350, potential defining diaphragm 352) can be engineered to effectively achieve the optimal tuning the ratio of Airy unit to confocal pinhole size or the size of the fiber/receiving optical element 356. Such an optimization has not been available for Brillouin microscopes before.

Mode Multiplexing without Parallel Processing

In some embodiments, the increase in throughput due to improved ratio (e.g., optimally designed ratio) between confocal pinhole (or the size of the fiber/receiving optical element) and size of Airy unit can be taken advantage of in a non-parallelized Brillouin spectrometer. This can allow use of conventional spectrometer architectures (e.g., single or multi-stage VIPA spectrometers), which may increase the case of adoption of such modality.

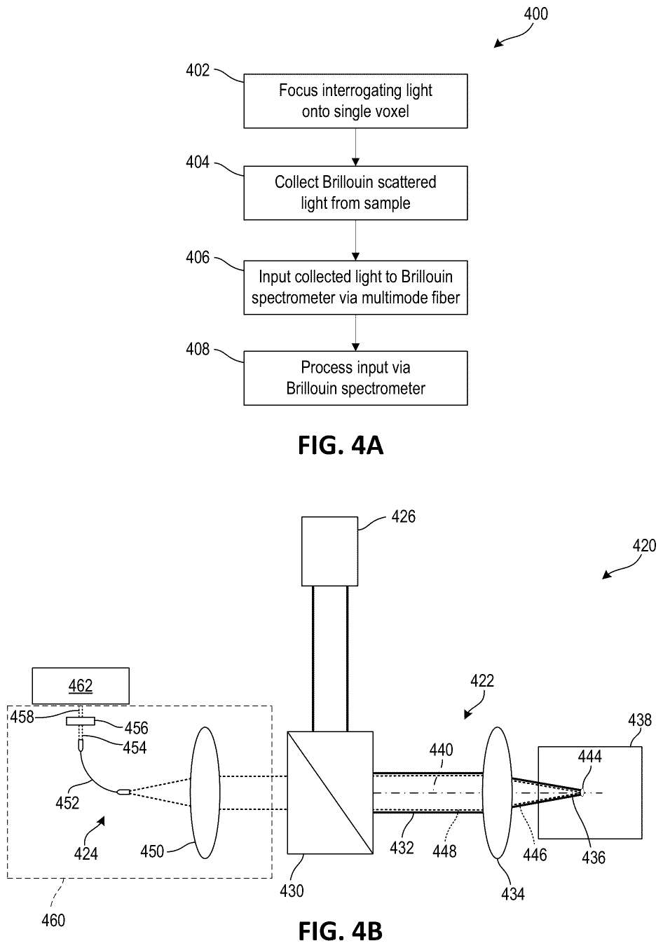

For example, FIG. 4A illustrates aspects of a method 400 for Brillouin microscopy employing mode multiplexing without parallel processing. The method 400 can initiate at process block 402, where interrogating light is focused on a single voxel within the sample. The method 400 can proceed to process block 404, where the Brillouin scattered light from the single voxel can be collected. In some embodiments, the Brillouin scattered light can be collected via a detection optical path (e.g., from the sample to an optical assembly of the microscope) that is on a same side of the sample as an illumination optical path for the interrogating light (e.g., from the optical assembly of the microscope to the sample). In some embodiments, the Brillouin scattered light can be collected from the detection optical path using the same objective lens in the optical assembly of the microscope as used to direct the interrogating light along the illumination optical path. In such embodiments, the objective lens can have a same (or substantially same) NA with respect to the interrogating and collected Brillouin scattered light. In some embodiments, the illumination and detection optical paths (e.g., from the objective lens to the sample) can be substantially coincident.

The method 400 can proceed to process block 406, where the collected Brillouin scattered light with multiple modes therein can be provided as a single input into a Brillouin spectrometer, for example, by a multiplexing module. In some embodiments, the collected Brillouin scattered light can be provided to the spectrometer, for example, via a multimode fiber having a core size of 100 μm or less (e.g., ≤50 μm or ≤25 μm, such as a ˜10 μm). Alternatively or additionally, a confocal pinhole can be used. In some embodiments, the resulting beam can have a non-Gaussian shape, and one or more beam shaping elements (e.g., SLM, DMD, deformable mirror, metalens, etc.) can be provided to reshape the output beam to have a Gaussian or nearly Gaussian shape. Alternatively or additionally, other options for beam reshaping and/or correction of multimode scrambling (e.g., in both coherent and incoherent scenarios) are also possible, such as but not limited to, adaptations of the techniques disclosed in Ploschner et al., “Seeing through chaos in multimode fibres,” Nature Photonics, August 2015, 9: pp. 529-38, and Lee et al., “Confocal 3D reflectance imaging through multimode fiber without wavefront shaping,” Optica, January 2022, 9(1): pp. 113-20, which techniques are incorporated herein by reference. In some embodiments, the beam shaping element(s) may be part of the multiplexing module, for example, disposed in an optical path between an output end of the multimode fiber and an input of the Brillouin spectrometer. Alternatively or additionally, in some embodiments, the beam shaping element(s) may be part of the Brillouin spectrometer, for example, disposed in an optical path upstream of the VIPA etalon.

The method 400 can proceed to process block 408, where the single input beam having multiple modes can be processed by the Brillouin spectrometer, for example, such that an optical train of the spectrometer induces spectral dispersion of the input beam onto a detector (e.g., a two-dimensional detector). In some embodiments, the Brillouin spectrometer can be a conventional non-parallelized Brillouin spectrometer, for example, having one or more VIPA etalons. Alternatively, the Brillouin spectrometer can instead be a parallelized spectrometer (e.g., similar to spectrometer 270 in FIG. 2C), but processing a single input. In some embodiments, the signal detected by the detector of the Brillouin spectrometer can be increased, for example, as compared to an input beam having a single mode (e.g., when using a single mode fiber to couple the collected Brillouin signal from the optical assembly of the microscopy to the spectrometer). In some embodiments, the Brillouin spectrometer (or a controller thereof) can image a single point in the sample based at least in part on the detected spectral dispersion of the processed single input beam. Alternatively or additionally, the Brillouin spectrometer (or a controller thereof) can assign a Brillouin metric (e.g., longitudinal modulus) to the single point in the sample based at least in part on the detected spectral dispersion of the processed single input beam. In some embodiments, imaging or assigning a metric to other points in the sample can be obtained by repeating method 400 for those other points.

Although some of blocks 402-408 of method 400 have been described as being performed once, in some embodiments, multiple repetitions of a particular process block may be employed before proceeding to the next decision block or process block. In addition, although blocks 402-408 of method 400 have been separately illustrated and described, in some embodiments, process blocks may be combined and performed together (simultaneously or sequentially). Moreover, although FIG. 4A illustrates a particular order for blocks 402-408, embodiments of the disclosed subject matter are not limited thereto. Indeed, in certain embodiments, the blocks may occur in a different order than illustrated or simultaneously with other blocks. In some embodiments, method 400 may comprise only some of blocks 402-408 of FIG. 4A.

FIG. 4B shows an exemplary Brillouin microscopy system 420 that employs mode multiplexing, for example, for use in performing the method 400 of FIG. 4A. In the illustrated example of FIG. 4B, the system 420 includes an optical assembly 422, a multiplexing module 424, a light source 426 (e.g., laser), and a Brillouin spectrometer 462. The multiplexing module 424 may be configured as a kit 460 for modification of an existing microscope. In some embodiments, the Brillouin spectrometer 462 may also be considered part of the kit 460. In some embodiments, the Brillouin spectrometer 462 may be a parallelized Brillouin spectrometer (e.g., similar to spectrometer 270 of FIG. 2C) operating with just a single input beam. Alternatively, in some embodiments, the Brillouin spectrometer 462 may be a non-parallelized Brillouin spectrometer, for example, any of the Brillouin spectrometers disclosed in U.S. Pat. No. 11,143,555, issued Oct. 12, 2021 and entitled “Methods and Devices for Reducing Spectral Noise and Spectrometry Systems Employing Such Devices,” U.S. Pat. No. 11,408,770, issued Aug. 9, 2022 and entitled “Brillouin Imaging Devices, and Systems and Methods Employing Such Devices,” and U.S. Pat. No. 12,019,018, issued Jun. 25, 2024 and entitled “Full-field Brillouin Microscopy Systems and Methods,” which spectrometers are incorporated by reference herein.

The optical assembly 422 includes a beam splitter 430 and an objective lens 434. An interrogating light beam 432 from the light source 426 is directed by beam splitter 430 along an illumination optical path (e.g., parallel to axial direction 440 in the illustrated example) and focused by objective lens 434 as a focused beam 436 onto a single voxel 444 within sample 438. Brillouin scattered light 446 from the single voxel 444 in the sample 438 is collected by objective lens 434 as collected beam 448 along a detection optical path (e.g., parallel to axial direction 440 in the illustrated example). In the illustrated example, the illumination optical path and the detection optical path are substantially coincident.

The collected beam 448 is then directed by beam splitter 430 to the multiplexing module 424 for further processing prior to input to the Brillouin spectrometer 462. The multiplexing module 424 includes a focusing lens 450 (e.g., tube lens) and multiplexing means 452. For example, the multiplexing means 452 can comprise a multimode fiber, for example, having a core size of 100 μm or less. In the illustrated example, the multiplexing module 424 also includes one or more beam shaping optical elements 456, for example, an SLM, DMD, deformable mirror, of metalens. However, in some embodiments, the beam shaping optical element(s) may instead be part of spectrometer 462 or the beam shaping optical element can omitted, for example, by appropriate design or selection of multiplexing means 452 and/or optical elements of the spectrometer 462 such that the input beam has an optical shape (e.g., substantially Gaussian) and/or entrance NA into the VIPA etalon.

Unlike conventional Brillouin microscopy setups, the beam 454 output from the multimode fiber of multiplexing module 424 may not be a collimated purely Gaussian beam. Thus, in some embodiments, the beam shaping optical element(s) 456 can be used to reshape the beam into a single cleaner (e.g., nearly-Gaussian) collimated beam 458, for example, by correcting for the scrambling occurring in the optical fiber (or for imperfections of the extended source behavior when using a large confocal pinhole instead of a multimode fiber). Several solutions can be employed to correct for the multimode scrambling in both coherent and incoherent scenarios, such as for example, using techniques discussed elsewhere herein.

In the system 420 of FIG. 4B, the throughput advantage can be quantified as the coupling advantage on the microscopy side due to optimal tradeoff between resolution and collection, times the increased coupling of a multimode fiber (or free-space pinhole) as compared to a single mode fiber. While the procedure introduces losses due to the beam shaping elements and spectral performance penalty due to the imperfect Gaussian nature of the shaped beam, it is expected that the balance between gain and loss associated with these procedures produces at least a two-fold net speed increase in Brillouin microscopy. Alternatively, in some embodiments, the losses due to beam shaping elements can be eliminated because the shape of the beam out of the multimode fiber of small core size of 100 μm or less provides a sufficiently clean beam shape to operate VIPA spectrometer without significant degradation. In some embodiments, the drawbacks of conventional Brillouin microscopy systems due to the long time required for beam shape optimization is largely not a consideration because the coupling arrangement from microscope to spectrometer can be optimized, fixed, and operated in the same condition at all times, thus requiring only a few optimization rounds per experiment.

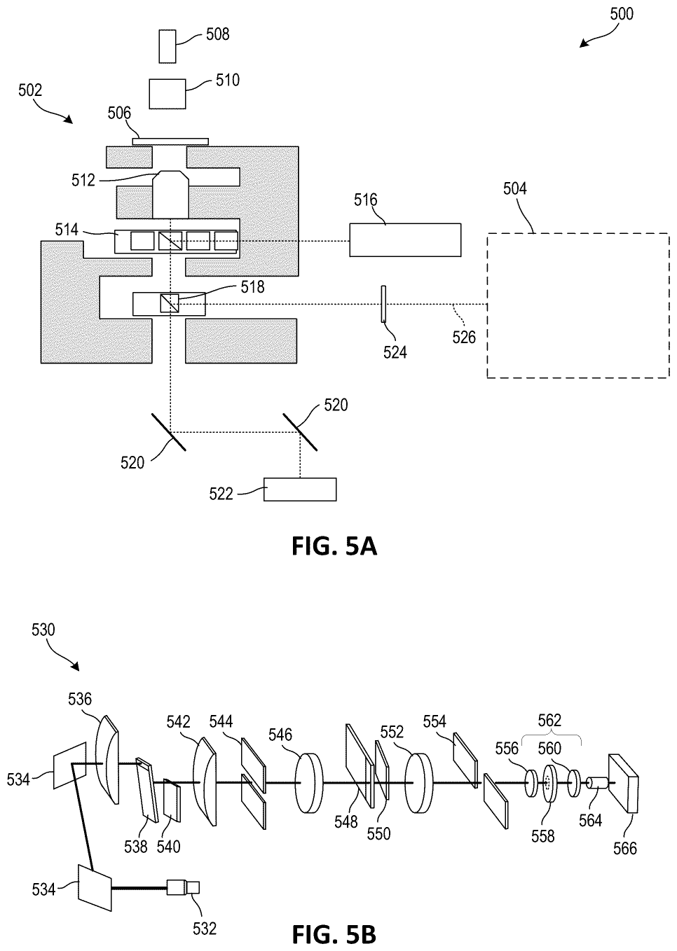

FIG. 5A shows a setup 500 of a microscope 502 modified by an add-on module 504 to provide multiplexed Brillouin spectroscopy of a sample 506. In the illustrated example, the microscope 502 includes an existing bright field imaging modality, for example, using bright field lamp 508 (e.g., <650 nm, such as 500-550 nm) and condenser 510 to illuminate a top side of the sample 506, and the light passing through sample 506 being collected by objective lens 512 on an opposite side of the sample. The bright field collected light can then be provided, for example, via one or more reflecting elements 520 (e.g., mirrors) to a camera 522 for detection. The microscope 502 also includes an existing fluorescence imaging modality, for example, using fluorescent light source 516 to illuminate a bottom side of the sample 506 via filter cube turret 514, and the fluorescence emitted by the sample 506 being collected by objective lens 512. The fluorescence can then be provided to camera 522 for detection, for example, along the same optical path from the objective lens 512 as the bright field imaging modality.

The multiplexed Brillouin spectroscopy modality can be added to the existing optical train of the microscope 502, for example, using a splitting module 518. In some embodiments, the splitting module 518 can comprise a dichroic (e.g., a 614 nm short pass). Alternatively or additionally, in some embodiments, the splitting module 518 can comprise one or more flip mirrors, for example, to allow the microscope to switch between the Brillouin spectroscopy modality and one of the other imaging modalities. In some embodiments, one or more optical elements can be provided along the optical path 526 between the Brillouin add-on module 504 and the microscope 502, such as but not limited to quarter-wave plate 524.

Referring to FIG. 5C, the Brillouin add-on module 504 can include an illumination arm 571, a Brillouin detection arm 573, and a calibration arm 575, each of which is connected to a polarizing beam splitter 572. In some embodiments, the optical paths of one, some, or each of the arms 571, 573, 575 and/or the optical path 526 to/from the microscope can be redirected via one or more reflecting elements 570 (e.g., mirrors), for example, to reduce a footprint of the respective optical path and/or the add-on module 504. The illumination arm 571 can include a light source 574 (e.g., laser), an isolator 576, a neutral density filter 578, a beam expander assembly 584 (e.g., formed by spherical lenses 580, 582), a half-wave plate 586, and a polarizer 588. The Brillouin detection arm 573 can include a Brillouin spectrometer 530, a fiber coupler 592, and an objective lens 590. The calibration arm 575 can include a standard material 598 (e.g., with a known Brillouin signature), a spherical lens 596, and a quarter wave plate 594.

In some embodiments, the configuration of add-on module 504 with polarizer 588 and calibration arm 575 can allow for in-situ calibration, for example, in a manner similar to that described with respect to FIG. 2D of U.S. Pat. No. 11,408,770, issued Aug. 9, 2022 and entitled “Brillouin Imaging Devices, and Systems and Methods Employing Such Devices,” which calibration operation is incorporated herein by reference. For example, polarizer 588 can be repositionable between a first orientation, which causes interrogating light from source 574 to be reflected by polarizing beam splitter 572 along the optical path 526 to the microscope 502, and a second orientation, which causes interrogating light from source 574 to pass through the polarizing beam splitter 572 to the calibration arm 575 for interrogating the standard material 598. The provision of quarter-wave plate 524 can allow Brillouin scattered light collected from the sample 506 and directed along optical path 526 to pass through polarizing beam splitter 572 to the Brillouin detection arm 573, and the provision of quarter wave plate 594 can allow Brillouin scattered light collected from the standard material 598 to be reflected by polarizing beam splitter 572 to the Brillouin detection arm 573.

Referring to FIG. 5B, the Brillouin spectrometer 530 can have a double-stage VIPA configuration. Collected Brillouin scattered light (from sample 506 via optical path 526 or standard material 598 via calibration arm 575) can be provided to fiber coupler 532, for example, via a multi-mode optical fiber attached to fiber coupler 592. The collected Brillouin scattered light can pass through an optical train of the spectrometer, for example, a cylindrical lens 536, first VIPA etalon 538, filter 540, cylindrical lens 542, mask 544, spherical lens 546, second VIPA etalon 548, filter 550, spherical lens 552, mask 554, filtering module 562, and linear polarizer 564, before being detected by a two-dimensional detector 566 (e.g., electron multiplying CCD). In the illustrated example, the filtering module 562 includes a spatial filter 558 disposed between a pair of spherical lens 556, 560 (e.g., at a Fourier plane). Configuration of the optical train and operation of the Brillouin spectrometer 530 can be substantially similar to that described in FIG. 7 of U.S. Pat. No. 11,143,555, issued Oct. 12, 2021 and entitled “Methods and Devices for Reducing Spectral Noise and Spectrometry Systems Employing Such Devices,” which configuration/operation is incorporated by reference herein. In some embodiments, the optical path through the spectrometer 530 can be redirected via one or more reflecting elements 534 (e.g., mirrors), for example, to reduce a footprint of the respective optical path and/or the add-on module 504.

### Computer Implementation Examples

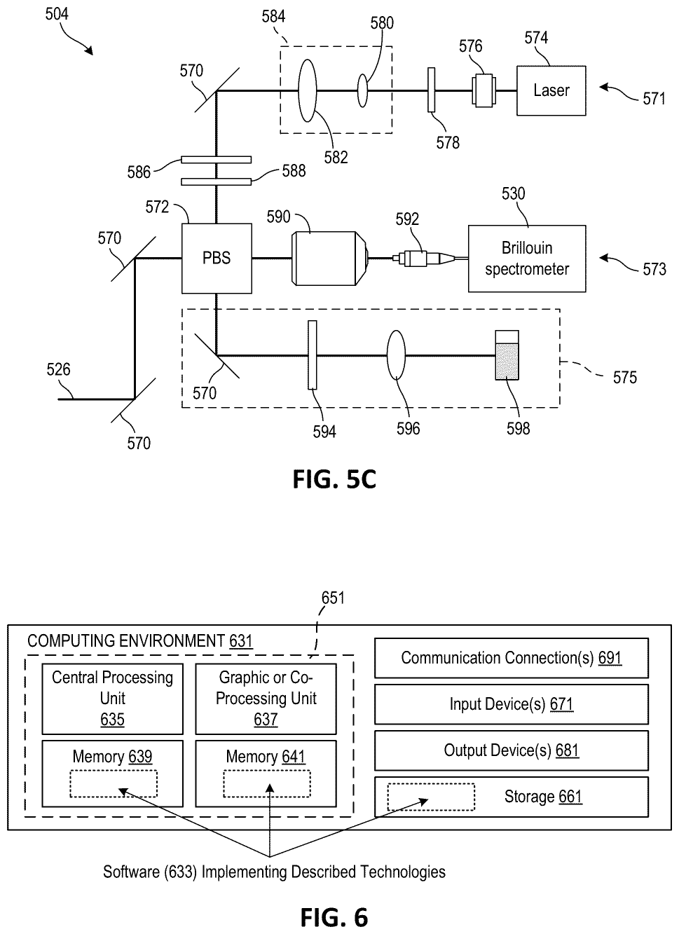

FIG. 6 depicts a generalized example of a suitable computing environment 631 in which the described innovations may be implemented, such as but not limited to control system 118, method 200, method 300, method 400, a controller of microscope 502, aspects of Brillouin add-on module 504, and/or aspects of Brillouin spectrometer 530. The computing environment 631 is not intended to suggest any limitation as to scope of use or functionality, as the innovations may be implemented in diverse general-purpose or special-purpose computing systems. For example, the computing environment 631 can be any of a variety of computing devices (e.g., desktop computer, laptop computer, server computer, tablet computer, etc.).

With reference to FIG. 6, the computing environment 631 includes one or more processing units 635, 637 and memory 639, 641. In FIG. 6, this basic configuration 651 is included within a dashed line. The processing units 635, 637 execute computer-executable instructions. A processing unit can be a central processing unit (CPU), processor in an application-specific integrated circuit (ASIC), or any other type of processor (e.g., hardware processors, graphics processing units (GPUs), virtual processors, etc.). In a multi-processing system, multiple processing units execute computer-executable instructions to increase processing power. For example, FIG. 6 shows a central processing unit 635 as well as a graphics processing unit or co-processing unit 637. The tangible memory 639, 641 may be volatile memory (e.g., registers, cache, RAM), non-volatile memory (e.g., ROM, EEPROM, flash memory, etc.), or some combination of the two, accessible by the processing unit(s). The memory 639, 641 stores software 633 implementing one or more innovations described herein, in the form of computer-executable instructions suitable for execution by the processing unit(s).

A computing system may have additional features. For example, the computing environment 631 includes storage 661, one or more input devices 671, one or more output devices 681, and one or more communication connections 691. An interconnection mechanism (not shown) such as a bus, controller, or network interconnects the components of the computing environment 631. Typically, operating system software (not shown) provides an operating environment for other software executing in the computing environment 631, and coordinates activities of the components of the computing environment 631.

The tangible storage 661 may be removable or non-removable, and includes magnetic disks, magnetic tapes or cassettes, CD-ROMs, DVDs, or any other medium which can be used to store information in a non-transitory way, and which can be accessed within the computing environment 631. The storage 661 can store instructions for the software 633 implementing one or more innovations described herein.

The input device(s) 671 may be a touch input device such as a keyboard, mouse, pen, or trackball, a voice input device, a scanning device, or another device that provides input to the computing environment 631. The output device(s) 681 may be a display, printer, speaker, CD-writer, or another device that provides output from computing environment 631.

The communication connection(s) 691 enable communication over a communication medium to another computing entity. The communication medium conveys information such as computer-executable instructions, audio or video input or output, or other data in a modulated data signal. A modulated data signal is a signal that has one or more of its characteristics set or changed in such a manner as to encode information in the signal. By way of example, and not limitation, communication media can use an electrical, optical, radio-frequency (RF), or another carrier.

Any of the disclosed methods can be implemented as computer-executable instructions stored on one or more computer-readable storage media (e.g., one or more optical media discs, volatile memory components (such as DRAM or SRAM), or non-volatile memory components (such as flash memory or hard drives)) and executed on a computer (e.g., any commercially available computer, including smart phones or other mobile devices that include computing hardware). The term computer-readable storage media does not include communication connections, such as signals and carrier waves. Any of the computer-executable instructions for implementing the disclosed techniques as well as any data created and used during implementation of the disclosed embodiments can be stored on one or more computer-readable storage media. The computer-executable instructions can be part of, for example, a dedicated software application or a software application that is accessed or downloaded via a web browser or other software application (such as a remote computing application). Such software can be executed, for example, on a single local computer (e.g., any suitable commercially available computer) or in a network environment (e.g., via the Internet, a wide-area network, a local-area network, a client-server network (such as a cloud computing network), or any other such network) using one or more network computers.

For clarity, only certain selected aspects of the software-based implementations are described. Other details that are well known in the art are omitted. For example, it should be understood that the disclosed technology is not limited to any specific computer language or program. For instance, aspects of the disclosed technology can be implemented by software written in C++, Java™, Python®, and/or any other suitable computer language. Likewise, the disclosed technology is not limited to any particular computer or type of hardware. Certain details of suitable computers and hardware are well known and need not be set forth in detail in this disclosure.

It should also be well understood that any functionality described herein can be performed, at least in part, by one or more hardware logic components, instead of software. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

Furthermore, any of the software-based embodiments (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means. In any of the above-described examples and embodiments, provision of a request (e.g., data request), indication (e.g., data signal), instruction (e.g., control signal), or any other communication between systems, components, devices, etc. can be by generation and transmission of an appropriate electrical signal by wired or wireless connections.

### CONCLUSION

Although the discussion above mentions “imaging,” the production of an actual image is not strictly necessary. Indeed, the mentions of “imaging” are intended to include the acquisition of data via the Brillouin and/or other imaging modalities where an image may not be produced. For example, the Brillouin spectrometer may produce graphical results of the Brillouin scattering, or produce values (or a graphical display of values) corresponding to the measured physical properties of the sample. Similarly, the imaging modalities may produce data or other information used (e.g., in the processing of the Brillouin data, or otherwise) without an actual image being produced. Accordingly, the use of the term “imaging” herein is intended to include such scenarios and should not be understood as limiting.

The references to “light” used herein are not intended to define a specific wavelength for operation of the disclosed optical systems. Rather, the term “light” is intended to include any wavelength in the electromagnetic spectrum at which microscopes and/or Brillouin spectroscopy systems typically operate. Such wavelengths can include but are not limited to 350-1000 nm, inclusive.

Although particular optical components and configuration have been illustrated in the figures and discussed in detail herein, embodiments of the disclosed subject matter are not limited thereto. Indeed, one of ordinary skill in the art will readily appreciate that different optical components or configurations can be selected and/or optical components added to provide the same effect. In practical implementations, embodiments may include additional optical components, fewer optical components, or other variations beyond those illustrated, for example, additional reflecting elements to manipulate the beam path to fit a particular microscope geometry. Accordingly, embodiments of the disclosed subject matter are not limited to the particular optical configurations specifically illustrated and described herein.

Any of the features illustrated or described herein, for example, with respect to FIGS. 1-6, can be combined with any other feature illustrated or described herein, for example, with respect to FIGS. 1-6, to provide systems, devices, structures, methods, and embodiments not otherwise illustrated or specifically described herein. All features described herein are independent of one another and, except where structurally impossible, can be used in combination with any other feature described herein. In view of the many possible aspects to which the principles of the disclosed technology may be applied, it should be recognized that the illustrated features are only examples and should not be taken as limiting the scope of the disclosed technology. Rather, the scope is defined by the following claims. I therefore claim all that comes within the scope and spirit of these claims.

1. A multiplexed Brillouin microscopy system comprising:
an optical assembly constructed to direct interrogating light to a sample along an illumination optical path and to collect Brillouin scattered light from the sample along a detection optical path, the illumination and detection optical paths being on a same side of the sample;
a multiplexing module constructed to receive the collected Brillouin scattered light from the optical assembly and to process the collected Brillouin scattered light into one or more input beams; and
a Brillouin spectrometer constructed to receive the one or more input beams from the multiplexing module and to simultaneously process the one or more input beams for detection.

2. The multiplexed Brillouin microscopy system of claim 1, wherein:
the optical assembly is constructed to direct the interrogating light as an axially-elongated beam within the sample, the axially-elongated beam extending along an axial direction that is parallel to the illumination optical path at the sample,
the Brillouin scattered light is generated at multiple points along the axial direction illuminated by the axially-elongated beam, and
the multiplexing module is constructed to convert the collected Brillouin scattered light into a multiplexed series of the input beams, each of the input beams corresponding to a different one of the multiple illuminated points.

3. The multiplexed Brillouin microscopy system of claim 2, wherein:
the optical assembly comprises a beam shaping optical element for generating the axially-elongated beam, and
the multiplexing module comprises means for multiplexing of axially-illuminated beams.

4. The multiplexed Brillouin microscopy system of claim 3, wherein the means for multiplexing of axially-illuminated beams comprises a linear array of non-occluding micromirrors, a linear array of confocal pinholes, or a linear array of optical fibers.

5. The multiplexed Brillouin microscopy system of claim 3, wherein the beam shaping optical element comprises a spatial light modulator, a digital micromirror device, a diffractive optical element, a metalens, or any combination of the foregoing.

6. The multiplexed Brillouin microscopy system of claim 2, wherein the Brillouin spectrometer comprises:
one or more first optical elements constructed to modify each of the input beams;
a VIPA etalon, the one or more first optical elements being disposed along an optical path between the input beams and the VIPA etalon;
one or more second optical elements constructed to focus an output of the VIPA etalon for each of the modified input beams, the VIPA etalon being disposed along the optical path between the one or more first optical elements and the one or more second optical elements; and
a two-dimensional detector configured to detect the focused beams from the one or more second optical elements, the one or more second optical elements being disposed along the optical path between the VIPA etalon and the two-dimensional detector,
wherein the one or more first optical elements are further constructed such that the modified input beams from the one or more first optical elements has a predetermined beam shape and entrance numerical aperture into the VIPA etalon.

7. The multiplexed Brillouin microscopy system of claim 2, wherein a ratio of a depth of focus of the illumination optical path for the interrogating light to a depth of focus for the detection optical path to collect the Brillouin scattered light is at least 2.

8. The multiplexed Brillouin microscopy system of claim 1, wherein:
the optical assembly is constructed to focus the interrogating light onto a single voxel within the sample, and
the multiplexing module is constructed to convert the collected Brillouin scattered light into a multiplexed series of the input beams, each of the input beams corresponding to a different mode emitted from the single voxel illuminated by the focused interrogating light.

9. The multiplexed Brillouin microscopy system of claim 8, wherein the multiplexing module comprises a photonic lantern that receives the collected Brillouin scattered light from the optical assembly at an input end and provides the multiplexed series of the input beams at an output end.

10. The multiplexed Brillouin microscopy system of claim 9, wherein:
the input end of the photonic lantern has a single aperture of at least 0.3 Airy unit; and
the output end of the photonic lantern comprises a linear array of single mode fibers.

11. The multiplexed Brillouin microscopy system of claim 8, wherein the multiplexing module comprises a plurality of single mode fibers in a bundle array, the single mode fibers being arranged such that the bundle array has a round configuration at an input end and a linear configuration at an output end, the multiplexed series of the input beams being provided from the output end of the bundle array.

12. The multiplexed Brillouin microscopy system of claim 8, further comprising:
an adjustable diaphragm disposed in an optical path between the optical assembly and the multiplexing module.

13. The multiplexed Brillouin microscopy system of claim 8, wherein the Brillouin spectrometer comprises:
one or more first optical elements constructed to modify each of the input beams;
a VIPA etalon, the one or more first optical elements being disposed along an optical path between the input beams and the VIPA etalon;
one or more second optical elements constructed to focus an output of the VIPA etalon for each of the modified input beams, the VIPA etalon being disposed along the optical path between the one or more first optical elements and the one or more second optical elements; and
a two-dimensional detector configured to detect the focused beams from the one or more second optical elements, the one or more second optical elements being disposed along the optical path between the VIPA etalon and the two-dimensional detector,
wherein the one or more first optical elements are further constructed such that the modified input beams from the one or more first optical elements have a predetermined beam shape and entrance numerical aperture into the VIPA etalon.

14. The multiplexed Brillouin microscopy system of claim 1, wherein:
the illumination optical assembly is constructed to focus the interrogating light onto a single voxel within the sample,
the one or more input beams is a single input beam corresponding to multiple modes emitted from the single voxel illuminated by the focused interrogating light; and
the multiplexing module comprises a multimode fiber having a core size less than or equal to 100 μm.

15. The multiplexed Brillouin microscopy system of claim 1, wherein:
the one or more input beams is multiple input beams, each input beam corresponding to a different illuminated voxel in the sample, and
the multiplexed Brillouin microscopy system further comprises a controller operatively coupled to the Brillouin spectrometer and comprising one or more processors and one or more non-transitory computer-readable storage media, the computer-readable storage media store computer-readable instructions that, when executed by the one or more processors, cause the one or more processors to image multiple points in the sample or assign Brillouin metrics to the multiple points in the sample based at least in part on the simultaneously-processed multiple input beams.

16. The multiplexed Brillouin microscopy system of claim 1, wherein:
the one or more input beams is multiple input beams, each input beam corresponding to a different mode emitted from a single illuminated voxel in the sample, and
the multiplexed Brillouin microscopy system further comprises a controller operatively coupled to the Brillouin spectrometer and comprising one or more processors and one or more non-transitory computer-readable storage media, the computer-readable storage media store computer-readable instructions that, when executed by the one or more processors, cause the one or more processors to image a single point in the sample or assign a Brillouin metric to the single point in the sample based at least in part on the simultaneously-processed multiple input beams.

17. The multiplexed Brillouin microscopy system of claim 1, wherein:
the one or more input beams is a single input beam corresponding to multiple modes emitted from a single illuminated voxel in the sample, and
the multiplexed Brillouin microscopy system further comprises a controller operatively coupled to the Brillouin spectrometer and comprising one or more processors and one or more non-transitory computer-readable storage media, the computer-readable storage media store computer-readable instructions that, when executed by the one or more processors, cause the one or more processors to image a single point in the sample or assign a Brillouin metric to the single point in the sample based at least in part on the processed single input beam.

18. A parallelized Brillouin spectrometer comprising:
one or more first optical elements constructed to modify each of a plurality of input beams;
a VIPA etalon, the one or more first optical elements being disposed along an optical path between the input beams and the VIPA etalon;
one or more second optical elements constructed to focus an output of the VIPA etalon for each of the modified input beams, the VIPA etalon being disposed along the optical path between the one or more first optical elements and the one or more second optical elements; and
a two-dimensional detector configured to detect the focused beams from the one or more second optical elements, the one or more second optical elements being disposed along the optical path between the VIPA etalon and the two-dimensional detector,
wherein the one or more first optical elements are further constructed such that the modified input beams from the one or more first optical elements have a predetermined beam shape and entrance numerical aperture into the VIPA etalon.

19. The parallelized Brillouin spectrometer of claim 18, wherein the one or more first optical elements comprise at least one beam shaping element, each beam shaping element comprising a spatial light modulator, a digital micromirror device, a diffractive optical element, or a metalens.

20. The parallelized Brillouin spectrometer of claim 18, wherein the one or more first optical elements comprise a plurality of optical fiber couplers, a beam expansion/reduction device, a cylindrical lens, or any combination of the foregoing.
